(19) United States
(12) Patent Application Publication
(10) Pub. No.: US 2005/0172486 A1
(43) Pub. Date: Aug. 11, 2005

(54) Member for sealing, baffling or reinforcing and method of forming same

(75) Inventors: David Carlson, Rochester Hills, MI (US); David J. Kosal, Richmond, MI (US); Douglas C. Larsen, Highland, MI (US); Jeffery C. Viaene, Almont, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/049,409

(22) Filed: Feb. 2, 2005

Related U.S. Application Data
(60) Provisional application No. 60/542,029, filed on Feb. 5, 2004.

(51) Int. Cl. B21D 39/00; F02F 11/00

(52) U.S. Cl. 29/897.2; 29/522.1

(57) ABSTRACT

There is disclosed a member for sealing, baffling and/or reinforcing components of an automotive vehicle. The assembly generally includes a carrier and an expandable material.

### CLAIM OF PRIORITY

To the extent applicable, the present invention claims the benefit of the priority of U.S. Provisional Application Ser. No. 60/542,029 filed Feb. 5, 2004, the contents of which are incorporated by reference herein.

### FIELD OF THE INVENTION

The present invention relates generally to a member, which is employed for providing sealing, noise/vibration reduction, structural reinforcement or a combination thereof.

### BACKGROUND OF THE INVENTION

For many years, industry and particularly the transportation industry, has been concerned with designing members for providing baffling, sealing, structural reinforcement or the like to automotive vehicles. For example, U.S. Pat. Nos. 5,755,486; 4,901,500; and 4,751,249, each of which is incorporated herein by reference, describe exemplary prior art devices for baffling, sealing or reinforcing. Such members typically include an expandable material, which may or may not be combined with other components for forming a seal, a baffle, a structural reinforcement or the like in a cavity of an automotive vehicle.

Often times, however, assembly of such members to the automotive vehicles or other articles of manufacture can present difficulties. Moreover, difficulties can be presented when designing a member that can be applied to various locations of an article of manufacture or various different articles of manufacture. It can also be difficult to form such members in an economical manner. Thus, the present invention seeks to provide a member for baffling, sealing or reinforcing that overcomes one of these difficulties or provides other advantages, which will become apparent upon reading the detailed description of the invention.

### SUMMARY OF THE INVENTION

The present invention is directed to a member or members designed to provide baffling, sealing or reinforcement to an article of manufacture such as an automotive vehicle. The member generally includes a carrier, an expandable material and one or more fasteners. Preferably, the expandable material can be heat activated or otherwise activated to provide the baffling, sealing or reinforcement to the article of manufacture.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of another alternative member in accordance with an aspect of the present invention.

FIG. 2 is a sectional view of the member of FIG. 1 being applied to a structure of an article of manufacture.

FIG. 3 is a perspective view of another alternative member in accordance with an aspect of the present invention.

FIG. 4 is a sectional view of the member of FIG. 3 being applied to a structure of an article of manufacture.

FIG. 5 is a sectional view of another alternative member in accordance with an aspect of the present invention.

FIG. 6 is a perspective view of another alternative member in accordance with an aspect of the present invention.

FIG. 7 is a sectional view of the member of FIG. 6 being applied to a structure of an article of manufacture.

FIG. 8 is a plan view of another exemplary alternative member being formed in accordance with an aspect of the present invention.

FIG. 9 is a plan view of another exemplary alternative member being formed in accordance with an aspect of the present invention.

FIGS. 9A-9D are plan views of alternative members in accordance with exemplary aspects of the present invention.

FIG. 10 is a perspective view of an exemplary member being formed in accordance with an aspect of the present invention.

FIG. 11 is a sectional view of the member of FIG. 10.

FIG. 12 is a cut-away perspective view of multiple members such as those of FIGS. 10 and 11 applied to a structure of an article of manufacture.

FIG. 13A-C illustrate alternative embodiments of exemplary members applied to a structure of an article of manufacture.

### DETAILED DESCRIPTION OF THE PREFERRED EMBODIMENT

The present invention is predicated upon the provision of a member for providing baffling, sealing, reinforcing or a combination thereof to an article of manufacture. It is contemplated that the member may be applied (e.g., assembled) to various article of manufacture such as boat, trains, buildings, appliances, homes, furniture or the like. It has been found, however, that the member is particularly suitable for application to automotive vehicles.

The member typically includes:
a) a carrier;
b) an expandable material disposed upon the carrier; and
c) Optionally, one or more fasteners, which may be attached to the carrier, the expandable material or both.

Exemplary carriers and expandable materials, which may be employed in conjunction with the present invention are disclosed in U.S. patent application Ser. No. 10/873,935 filed Jun. 22, 2004.

The member is typically assembled to an article of manufacture by positioning the member within a cavity or elsewhere upon the article. Thereafter, the expandable material is typically expanded to provide baffling, sealing or reinforcement to the article. Advantageously, the member can be formed using techniques that are efficient, inexpensive, expedient or a combination thereof.

The carrier of the present invention may be formed in a variety of shapes and in a variety of configurations according to the present invention. For example, the carrier may be planar or contoured, geometric or non-geometric, continuous or non-continuous, flexible or rigid, or otherwise configured. The carrier may also include only a single continuous part or may be formed of multiple parts directly connected to each other or connected through additional components. It is also contemplated that the carrier itself may be formed of an expandable material.

When used the one or more fasteners of the present invention may be provided for example as in mechanical fasteners, clips, snap-fits, screws, combinations thereof or the like. Furthermore, it is contemplated that the one or more fasteners may be formed integral of a singular material with the carrier or may be formed of a different material and may be removably attached to the carrier.

Furthermore, the fastener may be provided as a magnetic material or an adhesive material that can attach (e.g., adhere or magnetically secure) the carrier and/or the expandable material to a metal or other structure. In such an embodiment, the magnetic material or the adhesive material may be interspersed with the carrier or the expandable material. Alternatively, the magnetic material or the adhesive material may be disposed upon the carrier or the expandable material or may be otherwise connected to the carrier or the expandable material.

The carrier and the one or more fasteners may be formed of a variety of materials such as metal, polymers, elastomers, fibrous materials (e.g., cloth or woven materials), combinations thereof or the like. Preferably, the carrier, the one or more fasteners or both are at least partially formed of a polymeric material (e.g., a thermoplastic, an elastomer, a plastomer, a thermoset material, a plastic, a combination thereof or the like).

The expandable material may be formed from a variety of suitable materials. Preferably, the expandable material is formed of a heat activated material having foamable characteristics. The material may be generally dry to the touch or tacky and may be shaped in any form of desired pattern, placement, or thickness, but is preferably of substantially uniform thickness. In one embodiment, it is contemplated that the expandable material has a shape substantially similar or identical to a portion of the cavity into which the material is placed, only the expandable material will be substantially smaller (e.g. at least about 50%, 100%, 1000%, 2000% or 3000% smaller) than the portion of the cavity until expanded.

Though other heat-activated materials are possible for the expandable material, a preferred heat activated material is an expandable polymer or plastic, and preferably one that is foamable. A particularly preferred material is a polymeric formulation that includes one or more of an acrylate, an acetate, an elastomer, an epoxy resin a combination thereof or the like and can be configured to exhibit relatively high expansion, relatively low expansion or an expansion therebetween. For example, and without limitation, the expandable or foamable material may be based upon or include epoxy resin, ethylene methacrylate (EMA), ethylene vinyl acetate (EVA), rubber (e.g., nitrile butadiene rubber), combinations thereof or the like and may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of baffling, sealing or reinforcing foams are known in the art and may also be used to produce the foam. A typical foam includes a polymeric base material, such as one or more ethylene-based polymers which, when compounded with appropriate ingredients (typically a blowing and curing agent), expands and cures in a reliable and predictable manner upon the application of heat or the occurrence of a particular ambient condition. From a chemical standpoint for a thermally-activated material, the structural foam is usually initially processed as a flowable material before curing, and upon curing, the material will typically cross-link making the material incapable of further flow.

One advantage of the preferred foam materials over prior art materials is that the preferred materials can be processed in several ways. The preferred materials can be processed by injection molding, extrusion compression molding or with a mini-applicator. This enables the formation and creation of part designs that exceed the capability of most prior art materials.

While the preferred materials for fabricating the expandable material has been disclosed, the expandable material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy resin based material disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, the desired characteristics of the material include high glass transition temperature (typically greater than 70 degrees Celsius), relatively high expansion and adhesion durability properties. In this manner, the material does not generally interfere with the materials systems employed by automobile manufacturers.

In applications where the expandable material is a heat activated, thermally expanding material, an important consideration involved with the selection and formulation of the material comprising the foam is the temperature at which a material reaction or expansion, and possibly curing, will take place. Typically, the foam becomes reactive at higher processing temperatures, such as those encountered in an automobile assembly plant, when the foam is processed along with the automobile components at elevated temperatures or at higher applied energy levels, e.g., during paint curing steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges. Generally, suitable expandable foams have a range of expansion ranging from approximately 0 to over 1000 percent.

In another embodiment, the expandable material is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

It is contemplated that the expandable could be delivered and placed into contact with the carrier, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

Formation of the member of the present invention may include a variety of processing steps depending on the desired configuration of the member. In any event, it is generally contemplated that the carrier, the fastener and the expandable material may be manually attached to each other, automatically attached to each other or a combination thereof. Moreover, various processes such as molding (e.g., compression, injection or other molding), extrusion or the like may be used to form the carrier, the fastener or the expandable material individually and such processes may be employed to attach these components together.

As suggested, it is contemplated that the member of the present invention may include an expandable carrier. For example, the member may include an expandable carrier with an expandable material disposed thereon. In such an instance, the carrier may expand more or less than the expandable material.

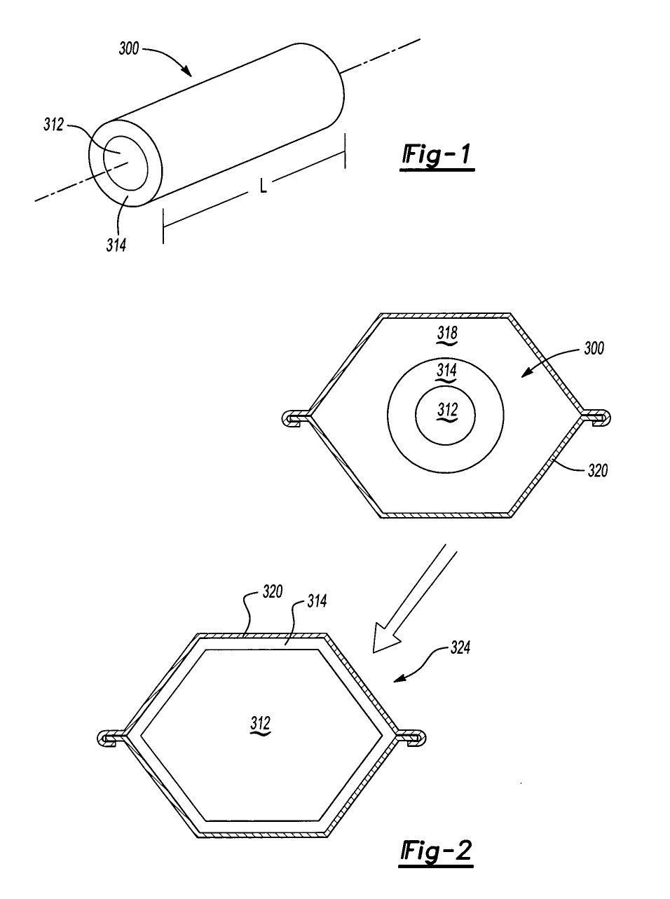

In FIG. 1, there is illustrated a member 300 that is formed of an expandable carrier 312 having an expandable material 314 disposed thereon. As shown, the member 300 is elongated and extends along its length (L). In the particular embodiment depicted, member 300 and the carrier 312 are substantially cylindrical (i.e., round or substantially circular in cross-section) and the expandable material 314 is substantially annular and cylindrical and extends at least partially about or, as shown, substantially entirely about the carrier 312.

In alternative embodiments, however, the member 300, the carrier 312, the expandable material 314 or all three may be formed in a variety of shapes such as block shaped (i.e., rectangular or square in cross-section), geometric, non-geometric or otherwise. Moreover, it is contemplated that the shape or configuration of the member 300, the carrier 312, the expandable material 314 or a combination thereof may change along the length (L) of the member. Typical lengths of the member 300 will range from about 10 cm or lower to about 100 cm or higher, more typically from about 20 cm to about 70 cm and still more typically from about 30 cm to about 50 cm.

The materials of the carrier 312 and the expandable material 314 may be any of the expandable materials discussed herein. The expandable material 314 may be the same as the material of the carrier 312 but is typically different. In the embodiment illustrated, although not required, the carrier 312 is formed of a material that has a greater volumetric expansion than the expandable material 314. In such an embodiment, the carrier 312 will typically volumetrically expand to between about 200% or lower and about 1500% or higher, more typically between about 350% and about 1000% and even more typically between about 500% and about 700% its original pre-expanded size. The expandable material 314, however, will typically volumetrically expand to between about 105% and about 1000%, more typically between about 140% and about 400% and even more typically between about 180% and about 300% its original pre-expanded size. Moreover, it should be understood that during expansion of the carrier 312 and the expandable material 314, the two may intermix with each other at their interface.

Formation of the member 300 may be accomplished using any of the techniques discussed herein and other techniques, which may be manual, automatic or a combination thereof. Typically, the member 300 is formed by forming the carrier 312 and applying the expandable material 314 thereto. Formation of the carrier 312 can be accomplished using molding techniques (e.g., compression, injection or blow molding), thermoforming techniques, extrusion or the like. Moreover, the expandable material 314 may be applied to the carrier 312 by, for example, molding (e.g., blowmolding, overmolding), extrusion, combinations thereof or the like. It is contemplated that these forming techniques may be employed from the carrier and the expandable material simultaneously or in sequence.

In one particular embodiment, the carrier 312 is formed by extrusion and the expandable material 314 is applied to the carrier 312 also by extrusion. In the embodiment, the carrier 312 and the expandable material are typically co-extruded although not required. In such an embodiment, one or more (e.g., two) extruders push the material of the carrier 312 and the material of the expandable material 314 toward one or more dies (e.g. a single die with multiple openings or multiple dies, each with their own opening) with multiple openings. The openings typically substantially correspond to the configuration of the carrier and the expandable material such that the materials may be pushed through the openings thereby forming an extrudate having the cross-section of the member. Thereafter, the extrudate may be cut into desired lengths to for the members.

Once formed, the member 300 can be applied to a structure of an article of manufacture. Referring to FIGS. 1 and 2, the member 300 is placed within a cavity 318 of a structure 320 (e.g., an A, B, C, or D-pillar) of an automotive vehicle. The member 300 may be placed loosely within the structure 320 or may be fastened within the structure 320 using one of the fasteners disclosed herein or other fasteners including magnets, mechanical fasteners, adhesive fasteners (e.g., adhesives, tapes), combinations thereof or the like.

Upon exposure to heat or other stimulus, the carrier 312, the expandable material 314 or both expand to at least partially, and more typically, substantially entirely fill the cavity 318. Typically, the carrier 312, the expandable material 314 or both, once expanded, wet and adhere to walls of the structure 320 defining the cavity 318 thereby forming a reinforced structural system 324. In this manner, the member 300 can provide substantial reinforcement to the structure 320 particularly when the expandable material 314 is a structural material. If the cross-section of the cavity 318 of the structure 320 is entirely spanned as shown in FIG. 20, the member 300 can also seal the cavity 318 against passage of materials therethrough and, if desired, can provide significant sound attenuation or baffling.

Generally, a variety of extruders may be employed to form the members, the materials, the carriers, the fasteners, a combination thereof or the like according to the present invention. According to one preferred embodiment of the invention, the extruder employed is a single screw extruder, which may also be known a kneader, a continuous kneader or a co-kneader, but may be a multi-screw (e.g., twin screw extruder). When used, the single screw extruder preferably includes a single segmented screw with interrupted screw flights and stationary pins both located in an extruder barrel. In operation, the single screw extruder preferably performs a distributive type mixing upon whatever material is forming a desired component of the present invention. As an example, such mixing may be obtained by having the screw rotate and reciprocate back and forth at the same time such that the material is mixed due to forward pumping but the material is also divided each time it passes a pin for causing the distributive type mixing.

Advantageously, the single screw extruder, the distributive mixing or both can provide sufficient intermixing of material ingredients while imparting lower energy to the material thereby maintaining and applying the material at a lower temperature. In turn, more reactive or lower activation temperature blowing agents, blowing agent activators or both may be employed particularly for expandable materials. As an example, it is contemplated that such an extruder can maintain and can apply material at temperatures of less than about 150° C., more typically less than about 135° C. and even more typically less than about 120° C. As an added advantage, it is contemplated that such an extruder is less likely to tear reinforcement fillers such as carbon fibers, glass fibers, nylon fibers or aramid pulp thereby allowing the formation of a material with greater integrity.

In an alternative embodiment, it is contemplated that a member may be composed of a plurality (e.g., 2, 3, 4, 5 or more) of sub-members. In such a circumstance, each of the sub-members can include a carrier and expandable material disposed thereon, or alternatively, one sub-member may include a carrier and another sub-member may include the expandable material.

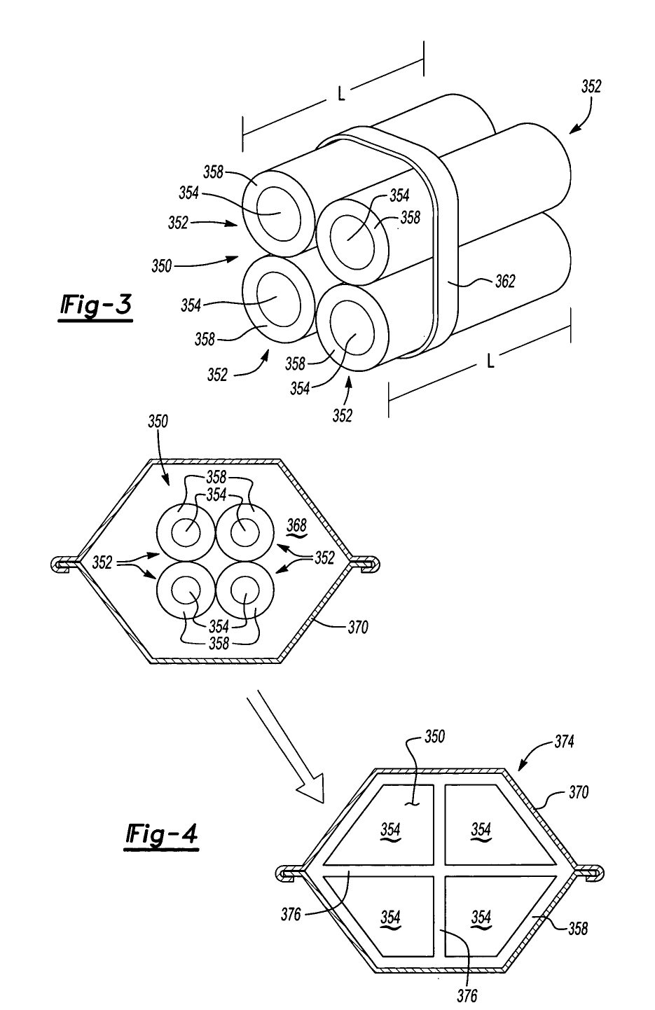

In FIG. 3, there is illustrated a member 350 that is composed of four sub-members 352. In the particular embodiment, each of the sub-members 352 is similar or substantially identical to the member 300 of FIG. 1. Thus, the description of the member 300 of FIG. 1, possible variations of that member 300 and the formation of that member 300 applies equally to each of the sub-members 352 of the member 350 of FIG. 3. Of course, it is contemplated that each of the sub-members 352 may be larger or smaller than the member 300 of FIG. 1.

As can be seen each of the sub-members 352 include a carrier 354 and an expandable material 358 disposed thereon. Each of the sub-members 352 are typically maintained (e.g., bundled) together by a fastening mechanism 362, although not required. A variety of fastening mechanisms may be employed and the mechanisms may maintain the sub-members 352 in contacting or spaced apart relationship relative to each other, at least prior to expansion of the expandable materials 358, the carrier 354 or both. For example, one or more adhesives, mechanical fasteners or the like may be employed for maintaining the sub-members 352 together.

In the particular embodiment depicted, the fastening mechanism 362 is a flexible member (e.g., a strap, string or otherwise) that extends about each of the plurality of sub-members 352 thereby bundling the sub-members 352 together. Moreover, the sub-members 352 are maintained together in contacting relation to each other and such that their lengths (L) are substantially coextensive (e.g., substantially parallel). Of course, the sub-members 352 may be maintained in a variety of other relationships relative to each other, if so desired.

Once formed, the member 350 is typically applied to a structure of an article of manufacture. Referring to FIGS. 3 and 4, the member 350 is placed within a cavity 368 of a structure 370 (e.g., an A, B, C, or D-pillar) of an automotive vehicle. The member 350 may be placed loosely within the structure 370 or may be fastened within the structure 370 using one of the fasteners disclosed herein or other fasteners.

Upon exposure to heat or other stimulus, the carrier 354, the expandable materials 358 or both expand to at least partially, and more typically, substantially entirely fill the cavity 368. Typically, the carriers 354, the expandable materials 358 or both, once expanded, adhere to walls of the structure 370 defining the cavity 368 thereby forming a reinforced structural system 374. In this manner, the member 350 can provide a substantial reinforcement to the structure 370, particularly when the expandable material 358 is a structural material.

Advantageously, by having multiple sub-members 352, the member 350, and particularly the expandable materials 358 of the sub-members 352, upon expansion, form one or more ribs 376 extending partially or substantially entirely across a cross-section of the expanded member 350. In the embodiment shown, the ribs 376 form a cross configuration, but may be varied depending on the number or configuration of the sub-members. If the cross-section of the structure 370 or system 374 is substantially entirely spanned as shown in FIG. 4, the member 350 can also seal the cavity against passage of materials therethrough and, if desired, can also provide significant sound attenuation or baffling.

In another embodiment, two or more different expandable materials might be disposed upon a carrier for forming a member (e.g., a reinforcing member) according to the present invention. In such an embodiment, it is contemplated the carrier may be expandable or non-expandable and at least one of the two or more different expandable materials may be formed of the same material as the carrier. Alternatively, each of the two or more different expandable materials may be formed of different materials than the carrier.

Moreover, it should be understood that a member having two or more different expandable materials disposed thereon can be formed and used in any of the protocols that were described with reference to FIGS. 1-4. In other words, and for example, the member may be formed by co-extrusion or another technique, and may be placed within a cavity of a structure by itself or as a sub-member along with other sub-members (e.g., as a bundle). It should also be understood that, in such an embodiment, the two or more different expandable materials and the carrier may be formed of any of the expandable materials discussed herein.

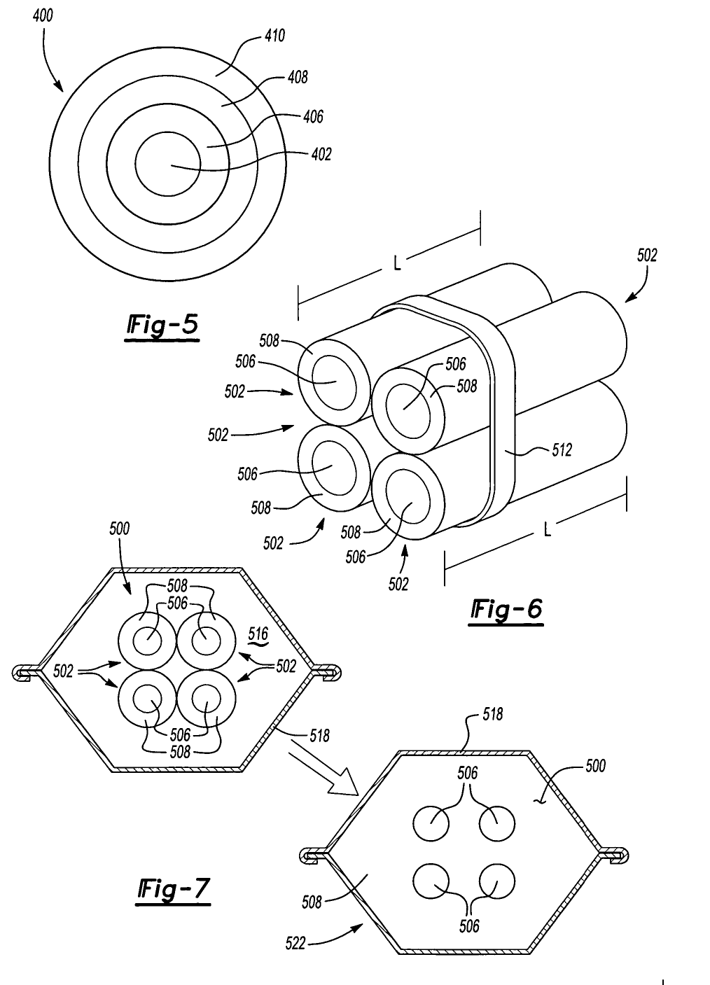

Referring to FIG. 5, there is illustrated an example of a member 400 having a carrier 402 with two or more different expandable materials disposed upon the carrier 402. As shown, a first or inner expandable material 406, a second or intermediate expandable material 408 and a third or outer expandable material 410 are disposed upon the carrier 402. In the particular embodiment shown, each of the first, second and third expandable materials 406, 408, 410 are annular and substantially surround the carrier 402, which is substantially cylindrical. Of course, the carrier 402 and the expandable materials 406, 408, 410 may be otherwise shaped if need or desired.

Depending upon the desired effect and the cavity or space to be filled, the expandable materials may be configured to volumetrically expand to various different levels. Thus, no limitations should be placed upon the expansion of the material unless otherwise stated. In the embodiment of FIG. 5, the carrier 402 and the intermediate expandable material 408 are configured to expand more than the inner and outer expandable materials 406, 410. Typically, carrier and the intermediate expandable material 402, 408 are configured to volumetrically expand to between about 200% or lower and about 1500% or higher, more typically between about 350% and about 1000% and even more typically between about 500% and about 700% their original size. The inner and outer expandable materials 460, 410, however, will typically volumetrically expand to between about 105% and about 1000%, more typically between about 140% and about 400% and even more typically between about 180% and about 300% their original size.

Advantageously, layering different expandable materials upon an expandable or non-expandable carrier can assist in providing reinforcement strength and integrity, which are believed to be provided by the spacing apart of the lower expanding materials (e.g., the inner and outer expandable materials) by the higher expanding material (e.g., the intermediate expandable material) in the embodiment of FIG. 5. Additionally, such layering can benefit from the sound absorption or sound attenuation, which is typically provided by the higher expanding materials. Moreover, the outer expandable material 416 can form ribs such as the ribs 376 of FIG. 4, particularly when a plurality of members such as the member 400 are employed as a sub-member along with other sub-members.

In still other embodiments, a member may include expandable material disposed upon a carrier wherein the carrier is typically non-expandable and, optionally, tubular. As used herein, the term tubular is intended to describe any form that defines an internal hollow space. Thus, a tubular member may have any shape cross-section that defines a hollow space unless otherwise specified. Moreover, it is contemplated that such a member may be employed alone or as having multiple sub-members.

In such an embodiment, the expandable material may be any of those mentioned herein and the expandable material may be applied to the carrier according to any of the techniques described herein. Additionally, the member may be formed of multiple sub-members, each having its own carrier and expandable material disposed thereon.

It is also contemplated that the carrier may be formed as partially tubular (i.e., partially defining an internal hollow space) or entirely tubular (i.e., substantially entirely defining an internal open space). In one particular embodiment, it is contemplated that the carrier may be provided as a metal stamping, which may be tubular or non-tubular.

Referring to FIGS. 6-7, there is illustrated a member 500 that is composed of a plurality (e.g., 2, 3, 4, 5 or more) sub-members 502. In the particular embodiment, each sub-member 502 is formed of a non-expandable tubular carrier 506 having an expandable material 508 disposed thereon. As shown, the member 500 and each of the sub-members 502 are elongated and extend along a length (L). In the particular embodiment depicted, the carriers 506 are substantially cylindrical (i.e., round or substantially circular in cross-section) and the expandable materials 508 are substantially annular and cylindrical and extend at least partially about or, as shown, substantially entirely about the respective carriers 506.

In alternative embodiments, however, the carriers 506 may be a variety of tubular shapes such as rectangular or square in cross-section, geometric, non-geometric or otherwise. Moreover, it is contemplated that the shape or configuration of the member 500 and/or sub-members 502 may change along the length (L) of the member. Typical lengths of the member 500 or sub-members 502 will range from about 10 cm or lower to about 100 cm or higher, more typically from about 20 cm to about 70 cm and still more typically from about 30 cm to about 50 cm.

The carriers 506 may be formed of a variety of non-expandable materials such as plastics (e.g., thermoplastics such as polyamides), metals, thermosets (e.g., molding compound such as sheet molding compound (SMC), bulk molding compound (BMC)) combinations thereof or the like. In one preferred embodiment, the carriers 506 are formed of a metal selected from aluminum, iron, steel, titanium, magnesium, combinations thereof or the like.

As can be seen, each of the sub-members 502 are typically maintained (e.g., bundled) together by a fastening mechanism 512, although not required. A variety of fastening mechanisms may be employed and the mechanisms may maintain the sub-members 502 in contacting or spaced apart relationship relative to each other, at least until expansion of the expandable material. For example, one or more adhesives, mechanical fasteners or the like may be employed for maintaining the sub-members 502 together.

In the particular embodiment depicted, the fastening mechanism 512 is a flexible member (e.g., a strap, string or otherwise) that extends about each of the plurality of sub-members 502 thereby bundling the sub-members 502 together. Moreover, the sub-members 502 are maintained together in contacting relation to each other and such that their lengths (L) are substantially coextensive (e.g., substantially parallel). Of course, the sub-members 502 may be maintained in a variety of other relationships relative to each other, if so desired.

Once formed, the member 500 is typically applied to a structure of an article of manufacture. In FIG. 7, the member 500 is placed within a cavity 516 of a structure 518 (e.g., an A, B, C, or D-pillar) of an automotive vehicle. The member 500 may be placed loosely within the structure 518 or may be fastened within the structure 518 using one of the fasteners disclosed herein or other fasteners.

Upon exposure to heat or other stimulus, the expandable materials 508 expands to at least partially, and more typically, substantially entirely fill the cavity 516 with the exception of the internal hollow portions of the carriers 506. Typically, the expandable material 508, once expanded, adheres to walls of the structure 518 defining the cavity 516 thereby forming a reinforced structural system 522. In this manner, the member 500 can provide a substantially reinforced structure 518, particularly when the expandable materials 508 are structural materials.

In one embodiment, the expandable materials of the embodiment of FIGS. 6-7 are each a two-component expandable material. As used herein, a two-component material is a material that at least partially gels, cures, expands or a combination thereof upon adding a first component to a second component. Examples of such first component/second component materials include epoxy/amine materials, epoxy/acid materials, polyurethane/isocyanate materials, combinations thereof or the like. It is also contemplated that the expandable materials may be a hybrid of one-component material and two component materials. In such an embodiment, the two-component material will typically partially gel or cure upon adding the first component to the second component such that the hybrid material can be securely attached to a carrier. Later, the one component material can be activated to expand and/or cures the hybrid material.

In one preferred embodiment, the two-component material of the hybrid material is formulated such that, upon addition of the first component to the second component, the material has a stoichiometric deficiency of liquid hardener such that the hybrid material gels to a substantially non-tacky state. As a result, the sub-members 502 may be combined, separated or moved relative to each other without any substantial adhesion to each other. In such an embodiment, the hybrid material is also preferably formulated with a one component material having one or more latent blowing agents, one or more latent curing agents or both such that the hybrid material can be activated to expand, cure or both upon exposure to heat (e.g., in an e-coat bake).

While it is contemplated that the two-component expandable material described above may be employed in place of any of the expandable materials or expandable carriers described herein, it has been found particularly advantageous to apply the material to the tubular carriers by dipping, rolling, spray or ejection coating, combinations thereof or the like. Thereafter, the tubes may be cut to the desired lengths to form the sub-members, which may be held together to form the member such as the member 500 of FIG. 6.

In still other embodiments, a member may be comprised of a carrier and an expandable material wherein the carrier (e.g., which may be expandable or non-expandable), the expandable material or both extend outwardly from a central location. In such an embodiment, it is contemplated that the carrier, the expandable material or both may extend outwardly in a variety of manners. For example, the carrier, the expandable material or both may at least partially or substantially extend directly outwardly, extend outwardly at an angle, spiral outwardly, a combination thereof or the like from the central location.

Moreover, it should be understood that a member having the carrier, the expandable material or both extending outwardly from a central location can be formed and used in any of the protocols that were described with reference to FIGS. 1-7 or the other embodiments of the present invention. In other words, and for example, the member may be formed by co-extrusion or another technique, and may be placed within a cavity of a structure by itself or as a sub-member along with other sub-members (e.g., as a bundle). It should also be understood that, in such an embodiment, the expandable material and the carrier may be formed of any of the materials discussed herein for carriers or expandable materials.

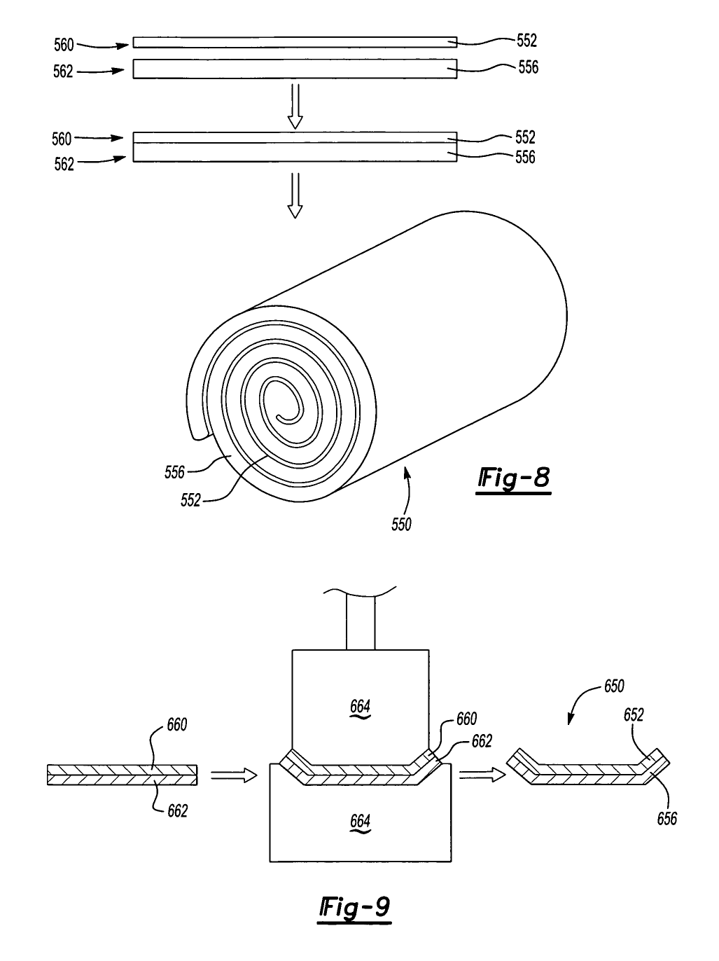

Referring to FIG. 8, there is illustrated an example of a member 550 (or a sub-member of a plurality of similar sub-members) having a carrier 552 and an expandable material 556 disposed thereon wherein the carrier 552 and the expandable material 556 extend outwardly from a central location 558. In the embodiment shown, the carrier 552 and the expandable material 556 are layered upon one another and they both spiral outwardly with the expandable material 556 at least partially, but preferably substantially entirely surrounding the carrier 552. As shown, the member 550 is substantially cylindrical, however, it may be otherwise configured as a block or other geometric or non-geometric shape.

While it is contemplated that the carrier 552 may be formed of a rigid material, an expandable material or both, the carrier 552 is typically formed of a flexible layer of material such as a fabric, a foil (e.g., an aluminum or steel foil), a paper product (e.g. cardboard) a combination thereof or the like. In one exemplary embodiment, the carrier is formed of a glass cloth such as a fiberglass woven fabric, a fiberglass woven roving or the like. The expandable material is typically an expandable structural foam material, but may be any of the other expandable materials discussed herein.

Although the member may be formed according to a variety of techniques, one preferred protocol is illustrated in FIG. 8. In FIG. 8, a layer 560 of material (i.e., the material of the carrier 552) is layered upon a second layer 562 of material (i.e., the expandable material 556). Thereafter, the first and second layers 560, 562 are rolled together (e.g., automatically, manually or a combination thereof) to form the member 550 with the first layer 560 becoming the carrier 560 and the second layer 562 becoming the expandable material. Upon formation, the member 550 may be cut to a desired length (e.g., any of the lengths of the members or sub-member of FIGS. 3-7) or otherwise shaped as desired.

Advantageously, layering the carrier 552 with the expandable material 556 provides an inexpensive member or sub-member 550 that can be effectively employed for sealing or baffling, but which is particularly effective for structural reinforcement.

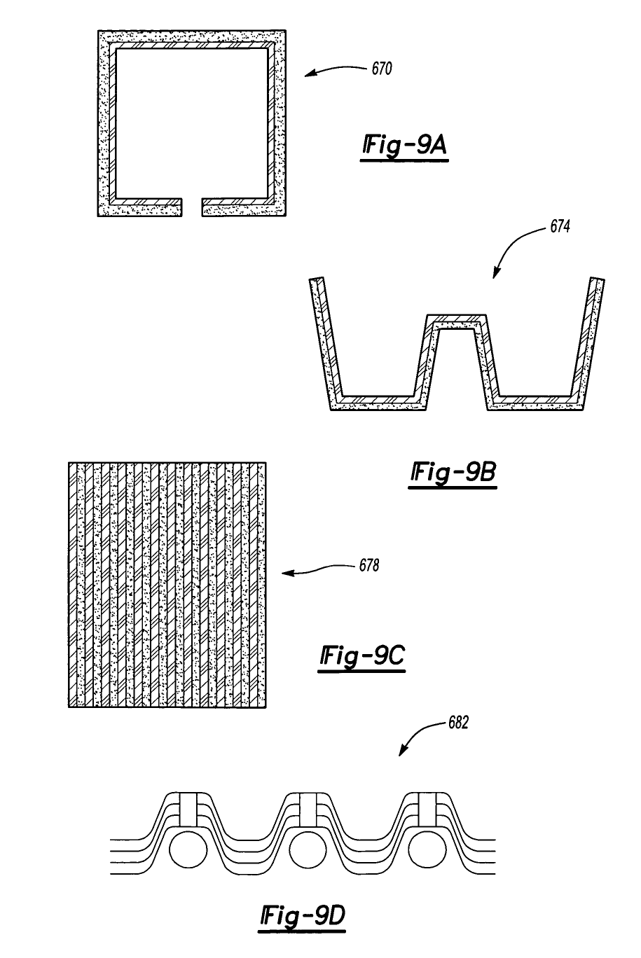

In another embodiment of the present invention, a polymeric material could be partially or fully cured to form the carrier with a desired shape, rigidity or both. Referring to FIG. 9, there is illustrated an example of a member 650 (or a sub-member of a plurality of similar sub-members) having a carrier 652 and an expandable material 656 disposed thereon. In the embodiment shown, the carrier 652 and the expandable material 656 are layered upon one another, but may be arranged adjacent to each other in a variety of configurations.

The carrier 652 may be formed of an expandable or non-expandable material. The carrier 652 is typically formed of a curable layer of material. The material for the carrier 652 may be any of the curable materials discussed herein and it is contemplated that the skilled artisan will be able to think of additional curable materials suitable for use in the present invention. Thus, it is contemplated that the material for the carrier 652 may be cured by a variety of stimuli such as radiation, photoinitiation, electro-magnetization, heat, a combination thereof or the like.

Although the member may be formed according to a variety of techniques, one preferred protocol is illustrated in FIG. 9. In FIG. 9, a layer 660 of material (i.e., the material of the carrier 652) is layered upon a second layer 662 of material (i.e., the expandable material 656). Such layering may be accomplished by coextrusion, application (e.g., brushing, dipping, manually or automatically laying) one layer on another, a combination thereof or the like. Thereafter, the first and second layers 660, 662 are shaped and the layer 660 of carrier material is at least partially or substantially entirely cured such that the member 650 maintains its desired shape. It should be understood that the shaping of the layers 660, 662 and the curing of the carrier layer 660 may take place simultaneously or sequentially.

In the particular embodiment illustrated, the layers 660, 662 are thermoformed by a die 664 that preferably is maintained at an elevated temperature. In alternative embodiments, a variety of other shaping techniques such as molding, stamping, or other manual or automatic shaping techniques may be employed. Also in the particular embodiment illustrated, the material of the carrier layer 660 is partially or fully cured by exposure to electromagnetic to provide the carrier 652 in a relatively rigid state.

As shown, the layers 660, 662 are shaped to create a member 650 that has a U-shaped cross-section. Advantageously, however, the member 650 may be shaped as desired to allow it to fit into a cavity of or be placed adjacent a structure of an article of manufacture such as an automotive vehicle. In this manner the expandable material 656, the carrier 652 or both can be activated to expand and cure and preferably wet and adhere to walls of the structure for providing reinforcement to the structure such as has been previously described.

As discussed, the laminate members may be formed in a variety of other configurations and shapes. Referring to FIGS. 9A-9D, examples of such alternative laminates are illustrated. In FIG. 9A, a laminate member 670 has been formed with a square or rectangular cross-section. In FIG. 9B, a laminate member 674 has been formed with a W-shaped cross-section. In FIG. 9C, a laminate member 678 has been formed with multiple layers of carrier intermittent with multiple layers of expandable material. In FIG. 9D, a laminate member 682 has been formed with a multiple wave cross-section.

According to still another embodiment, it is contemplated that several sub-members may be formed as segments such that multiple sub-members may be located within a structure for forming a reinforcement member or system. Typically each of the sub-members will include a carrier with expandable material disposed thereon. In such an embodiment, the carrier or the expandable material of each of the sub-members will typically define an internal open space that is substantially enclosed (i.e., at least 40%, 60%, 80% or more enclosed) by the carrier, the expandable material or a combination thereof. Although, not required, the internal open space typically has a volume of at least about 2 mm³, more typically at least about 4 mm³ and even more typically at least about 6 mm³ and still more typically at least about 9 mm³. Although also not required, the internal open space typically has a volume that is less than about 1 dm³, more typically less than about 5 cm³, even more typically less than 3 cm³ and still more typically less than 1.5 cm³.

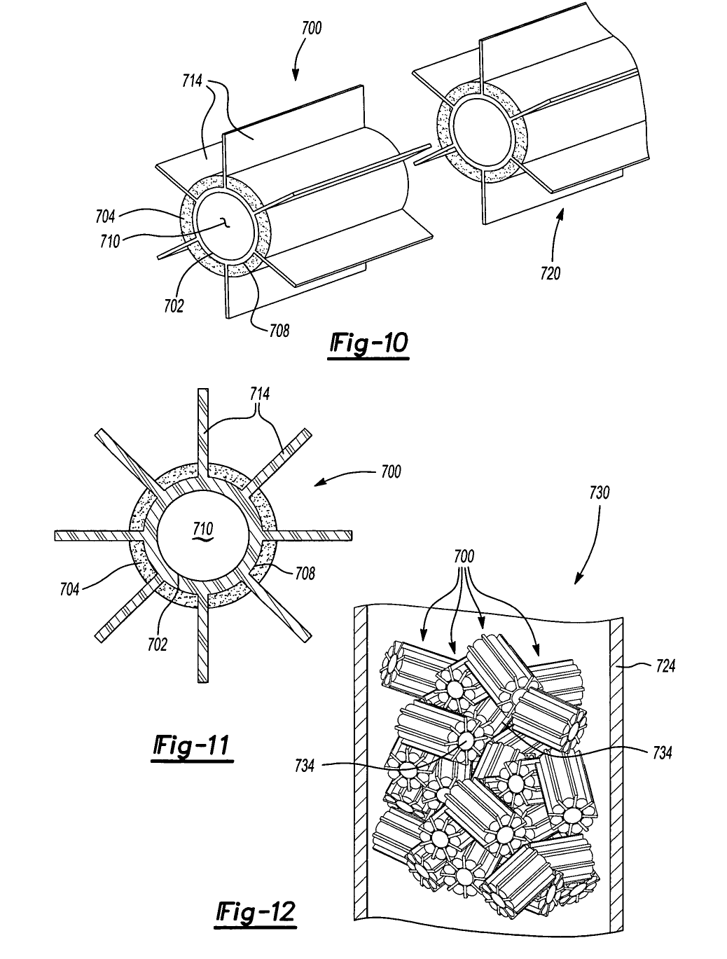

Referring to FIGS. 10-11, there is illustrated a sub-member 700 being formed according to a preferred embodiment of the present invention. In the illustrated embodiment, the sub-member 700 includes a carrier 702 and an expandable material 704 disposed upon the carrier 702.

The carrier 702 is shown as having an enclosure portion 708 that substantially encloses an internal open space 710. The enclosure portion 708 illustrated is cylindrical with a circular or annular cross-section. However it is contemplated that various shapes and cross-sections may be employed such as square, rectangular, block shaped, cubic, geometric, non-geometric or the like.

Multiple (e.g., 3, 4, 5, 6 or more) extensions 714 extend outwardly from the enclosure portion 708 and away from the internal open space 710. The extensions 710 shown extend radially outward, are coextensive with a length of the enclosure portion 708 and are generally rectangular in shape. It is contemplated however, that the extensions 714 may be alternately configured and/or shape if desired.

The carrier 702 of the sub-member 700 may be formed of any of the materials discussed herein including expandable materials. In a preferred embodiment, however, the material for the carrier 702 is a polymeric material, which may be selected from any of those disclosed herein or others.

Typically, the expandable material 704 is typically located between pairs of extensions 714, although not required. It is contemplated that the expandable material 704 may be located upon the enclosure portion 708, the extensions 714 or both. In the illustrated embodiment, the expandable material 704 is disposed upon the enclosure portion 708 of the carrier 702 and also partially disposed upon the extensions 714. The illustrated embodiment also shows the expandable material 704 as being located between each pair of the extensions 714. However, the expandable material 704 may only be located between select pairs of the extensions such as intermittent pairs of extensions 714 as further discussed below.

Generally, it is contemplated that the sub-member 700 or multiple sub-members 700 may be formed according to any of the techniques discussed herein. In one preferred embodiment, the expandable material 704 is co-extruded upon carrier material to form an extrudate 720 as shown in FIG. 10. As used herein, co-extrusion can mean that the carrier material is extruded substantially continuously with the expandable material or that the carrier material is otherwise continuously provided as the expandable material is extruded thereon. Thereafter, the extrudate 720 is sliced into segments that form the sub-members 700. Typically the sub-members 700 are cut or sliced to be segments of at least 0.5 mm, more typically at least 1.0 cm and even more typically at least 1.5 cm in length or along the direction of extrudate 720. Also typical, the sub-members 700 are cut or sliced to be segments of less than 1.0 dm, more typically less than 5 cm and even more typically less than 3.0 cm in length or along the direction of extrudate.

For forming a reinforcement, sealing or baffling member or system, multiple (e.g., at least 10, 20, 30 or more) sub-members 700 are typically placed or located within a cavity of a structure of an article of manufacture. In FIG. 12, multiples sub-members have been located within a structure 724 (e.g., a pillar) of an automotive vehicle. Thereafter, the expandable material 704 is activated to flow and/or expand such that the expandable material 704 adheres the multiple sub-members 700 together into an agglomeration and also adheres the multiple sub-members or the agglomeration to walls of the structure 724. Advantageously, the agglomeration serves as, or forms a reinforcement, sealing or baffling member or system 730.

While the multiple sub-members 700 may be initially placed in a cavity of a structure a loose or individual unconnected sub-members 700, in one preferred embodiment, the sub-members 700 are attached to each other to form a member and are then inserted into a cavity of a structure. In such an embodiment, the multiple sub-members 700 are typically placed in a shaping device (e.g., a mold) and a stimulation such as heat may be applied to the sub-members 700 such that the sub-members 700 attached to each other to form the member 730, preferably in a shape that substantially corresponds to the cavity of the structure 724, although not necessarily required.

The sub-members 700 can be attached to each according to a variety of protocols. For example, an adhesive material may introduced into the mold (e.g., coated upon the sub-members) such that the sub-members 700 attach to each other to form the member 724. In a preferred embodiment, the material of carriers 702, the expandable material 704 or both tends to soften or melt (preferably without activating) at the elevated temperature in the shaping device thereby allowing the sub-members 700 to attach (e.g., adhere or bond) to each other to form the member 724.

Whether the sub-members 700 are placed in the cavity loose to form a member 724 or as a pre-formed member 724, upon activation of the expandable material 704, the member 724 will typically undergo expansion due to the expansion of the expandable material 704. In this manner, the member 724 can more thoroughly fill the cavity of the structure 724 for effectively providing sealing, baffling and/or particularly reinforcement to the structure 724.

It will be understood that the system of FIGS. 10-12 can be used to reinforce, seal or baffle many structures depending upon the number of sub-members applied to the structure. Additionally, it will be understood that the system or member 730 can, in certain embodiments, provide a desirable amount of reinforcement to a structure while, at the same time, have a substantial amount of open interstitial space 734 within the cavity. As used herein, open interstitial space is defined to include open space between at least two sub-members and internal open space of the sub-members. It is contemplated that the member or system can include at least 20%, more typically at least 30% and even more typically at least 40% open interstitial space after expansion of the expandable material. It is also contemplated that the member or system will typically include less than 80%, more typically less than 70% and even more typically less than 60% open interstitial space after expansion of the expandable material.

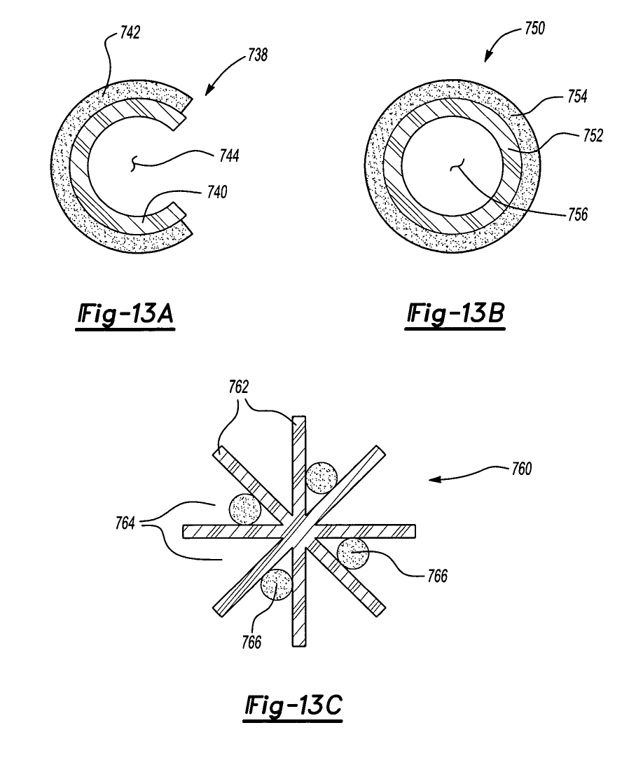

As suggested previously, the sub-members of an embodiment such as the embodiment of FIGS. 10-12 may be provided in a variety of configurations. Examples of such configurations are shown in FIGS. 13A-13C. In FIG. 13A, a sub-member 738 is illustrated with a carrier 740 that has a C-shaped cross-section with expandable material 742 disposed on an outer surface of the C-shaped cross-section. As shown, the carrier 740 is substantially entirely an enclosure portion that defines an internal open space 744 within the C-shaped cross-section. In FIG. 13B, a sub-member 750 is illustrated with a carrier 752 that has a circular, annular or O-shaped cross-section with expandable material 754 disposed on an outer surface of the cross-section. Again, as shown, the carrier 752 is substantially entirely an enclosure portion that defines an internal open space 756 within the cross-section. In FIG. 13C, a sub-member 760 is illustrated as being comprised of multiple axially extending extensions 762 defining multiple cavities 764. As shown, expandable material 766 is placed only in intermittent cavities 764 although it could be placed in a fewer or greater number of the cavities 764.

In addition to the methods of forming members discussed above, several other methods or techniques may also be employed for forming the members of the present invention, particularly for forming the members or sub-members of FIGS. 1-13C. As one example, expandable material may be applied to a carrier by dunking of the carrier into liquid expandable material and subsequently shaping the carrier and expandable material to a desired shape (e.g., by pultrusion). In such an example, the carrier may be formed of a variety of materials, but is preferably formed of a fibrous or fabric material such as a polymeric fabric, a carbon fabric, a glass (e.g., fiberglass) fabric, a cellular, paper or cellulose fabric, any of the other fabrics disclosed herein, combinations thereof or the like such that the carrier can be impregnated by the liquid expandable material. Shaping of the member may be accomplished by a variety of techniques, which may be manual, automatic or a combination thereof. In one embodiment, the impregnated carrier is placed in a die for shaping.

In other embodiments, a member may be formed by molding its carrier and its expandable material simultaneously (e.g., partially or entirely at the same time) particularly where both the carrier and the expandable material are expandable. For example, a first and second expandable material may be positioned in a compression molding die having a first portion configured for shaping the carrier and a second portion configured for shaping the expandable material. In the example, the first expandable material, which is typically different from the second expandable material, is compression molded in the first portion of the die to form the carrier simultaneously as the second expandable material is compression molded in the second portion of the die to form the expandable material of the member as disposed at least partially upon the carrier. As another example, the first expandable material may be injected into a first portion of a two-shot injection molding die and the second expandable material may be injected into a second portion of the two shot injection molding die. In this example, the first expandable material, which is typically different from the second expandable material, is injection molded in the first portion of the die to form the carrier simultaneously as the second expandable material is injection molded in the second portion of the die to form the expandable material of the member as disposed at least partially upon the carrier

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A method of providing sealing, baffling or reinforcement for a structure of an automotive vehicle, comprising:
providing a carrier material;
extruding a first expandable material onto the carrier material; and
cutting the carrier material and the first expandable material to form a member for sealing, baffling or reinforcement of the structure of the automotive vehicle, the member having a carrier with the first expandable material disposed thereon, wherein:
i. the first expandable material is configured to volumetrically expand to between about 140% and about 400% of its original size; and
ii. the first expandable material extends substantially entirely about the carrier.

2. A method as in claim 1 further comprising placing the member into the structure of the automotive vehicle and expanding the first expandable material to adhere the first expandable material to walls of the structure.

3. A method as in claim 1 wherein the carrier material is formed of a second expandable material and the second expandable material is configured to expand to between about 350% and about 1000% its original size.

4. A method as in claim 1, wherein the member includes one or more fasteners, which are integrally extruded as part of the carrier, the fastener is fabricated separately from the extruded carrier and connected thereto in a separate step, or a combination thereof.

5. A method as in claim 1 wherein the carrier is cylindrical and the expandable material is annular and substantially surrounds the carrier.

6. A method as in claim 1, wherein providing the carrier material includes extruding the carrier material simultaneously with the expandable material, extruding the carrier material prior to the coextrusion of the expandable material upon the carrier or extruding the carrier material such that it is coextruded with the expandable material and the resulting coextrusion is further extruded to form the profile configuration.

7. A method as in claim 1, wherein the expandable material is adapted for forming a sealing material, an acoustical material, an adhesive, a structural foam, or a combination of at least two of the foregoing.

8. A method as in claim 1, wherein the expandable material is a material that is thermally deformable at the temperature of extrusion, but upon thermal activation at an elevated temperature will cross link to form a thermoset material.

9. A method as in claim 8, wherein the expandable material includes a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof.

10. A method as in claim 1, wherein the carrier is formed at least partially of a material selected from a metal, a polymeric material, a carbon fiber, graphite, glass, or combinations thereof.

11. A method as in claim 10, wherein the polymeric material is selected from polyethylene terephthalate, high density polyethylene, polyvinyl chloride, low density polyethylene, polypropylene, polystyrene, a polycrystalline material, an amorphous material, a polyolefin, a polyamide, a polyester, polystyrene, a poly(meth)acrylate, a polyvinyl chloride, a polysulfone or a combination thereof.

12. A method as in claim 1 wherein the expandable material includes a property or ingredient selected from a flame retardant, water remediation ingredient, an electrically conductive ingredient, a sound absorption characteristic.

13. A method as in claim 1 wherein the expandable material is disposed upon the carrier by cross-head extrusion.

14. A method of providing sealing, baffling or reinforcement for a structure of an automotive vehicle, comprising:
providing a carrier material;
extruding a first expandable material onto the carrier material; and
cutting the carrier material and the first expandable material to form multiple sub-members, each of the multiple sub-members including a carrier with the first expandable material disposed thereon, wherein:
i. the first expandable material is configured to volumetrically expand to between about 140% and about 400% of its original size.

15. A method as in claim 14 wherein the carrier of each of the multiple sub-members defines an internal open space having a volume of between about 30 mm³ and about 5 cm³ and each of the multiple sub-members are segments of less that about 1 decimeter.

16. A method as in claim 15 further comprising placing the multiple sub-members within a cavity of the structure of the automotive vehicle wherein the multiple sub-members include at least 10 sub-members.

17. A method as in claim 16 further comprising shaping the multiple sub-members to form a reinforcement member that substantially corresponds in shape to the cavity.

18. A method as in claim 17 further comprising expanding the first expandable material to adhere the reinforcement member to the structure.

19. A method as in claim 14 wherein the multiple sub-members are comprised of a first sub-member and a second sub-member; and
further comprising placing the first sub-member and the second sub-member in the structure with lengths of the first and second sub-members being substantially coextensive.

20. A method as in claim 19 wherein the carrier is formed of second expandable material.

21. A method as in claim 20 further comprising expanding the first and second expandable materials such that the first expandable material forms ribs within the structure.

22. A method as in claim 14 wherein the carrier material is formed of a second expandable material and the second expandable material is configured to expand to between about 350% and about 1000% its original size.

23. A method of providing sealing, baffling or reinforcement for a structure of an automotive vehicle, comprising:
providing a layer of carrier material;
providing a layer of a first expandable material onto the layer of carrier material for forming a laminate; and
shaping the laminate including the layer of carrier material and the layer of expandable material to form a member having a carrier with the expandable material disposed thereon; wherein:
ii. the first expandable material is configured to volumetrically expand to between about 140% and about 400% of its original size.

24. A method as in claim 23 wherein the shaping step includes rolling the layer of carrier material and the layer of first expandable material together and cutting the laminate to form a reinforcement member.

25. A method as in claim 24 wherein the rolling step is carrier out after the cutting step.

26. A method as in claim 25 wherein the providing of the first layer of expandable material includes extruding the first layer of expandable material.

27. A method as in claim 26 wherein the carrier of the member spirals outwardly from adjacent the center of the member.

28. A method as in claim 23 wherein the shaping step includes thermoforming the laminate with a die to form the member.

29. A method as in claim 28 wherein the member has a U-shaped cross-section upon formation.

30. The member as in claim 23, wherein the member includes one or more fasteners, which are integrally extruded as part of the carrier, the fastener is fabricated separately from the extruded carrier and connected thereto in a separate step, or a combination thereof.
